(19) United States
(12) Patent Application Publication
(10) Pub. No.: US 2015/0098694 A1
(43) Pub. Date: Apr. 9, 2015

(54) RECORDING CONTROL APPARATUS, RECORDING CONTROL METHOD, AND RECORDING MEDIUM

(71) Applicant: CANON KABUSHIKI KAISHA, Tokyo (JP)

(72) Inventor: Ichiko Mayuzumi, Yokohama-shi (JP)

(21) Appl. No.: 14/504,221

(22) Filed: Oct. 1, 2014

(30) Foreign Application Priority Data
Oct. 4, 2013 (JP) 2013-209217

(51) Int. Cl. G11B 27/28; H04N 9/82; G11B 31/00; H04N 5/76

(52) U.S. Cl. CPC G11B 27/28; H04N 5/76; H04N 9/8205; G11B 31/006
USPC 386/295

(57) ABSTRACT

A recording control apparatus includes a generation unit configured to generate metadata to determine whether a first subdirectory included in a first directory of a recording device includes an image to be restricted from being deleted from the recording device, and a recording control unit configured to cause the first subdirectory to record a plurality of first images and cause the first directory to record first metadata generated by the generation unit.

### BACKGROUND

1. Field of the Embodiments

The following exemplary embodiments relate to a recording control apparatus that can store video data obtained by a monitoring camera together with metadata thereof. Further, the following exemplary embodiments relate to a recording control method and a recording medium.

2. Description of the Related Art

A monitoring camera system is generally required to store recorded images for a long time while a monitoring camera continuously captures new images. Therefore, the data amount of the recorded images becomes massive.

As discussed in Japanese Patent Application Laid-Open No. 2003-134441, it is conventionally known to delete the oldest image if it is necessary to write a new image into a recording device in a state where a plurality of images is already recorded in the recording device.

Further, as discussed in Japanese Patent Application Laid-Open No. 2009-135811, it is conventionally known to change the recording method in such a way as to record only a limited number of images captured when a predetermined event has occurred if the recording capacity is insufficient for continuous recording of images.

However, according to the conventional methods, it may fail to appropriately record a video of a scene that is interesting to a user.

For example, according to the method discussed in Japanese Patent Application Laid-Open No. 2003-134441, the recorded data of the scene that is interesting to a user may be automatically deleted when the recording capacity becomes insufficient.

Further, according to the method discussed in Japanese Patent Application Laid-Open No. 2009-135811, the scene that is interesting to a user may not be recorded if the recording capacity becomes insufficient.

### SUMMARY

The following exemplary embodiments are intended to appropriately record video data of a scene that is interesting to a user.

A recording device described in the following exemplary embodiment has the following characteristic features.

More specifically, an aspect of the present invention provides a recording control apparatus, including a generation unit configured to generate metadata to determine whether a first subdirectory included in a first directory of a recording device includes an image to be restricted from being deleted from the recording device, and a recording control unit configured to cause the first subdirectory to record a plurality of first images and cause the first directory to record first metadata generated by the generation unit.

Further, a recording device described in the following exemplary embodiment has the following characteristic features.

More specifically, another aspect of the present invention provides a recording control apparatus, including a recording unit configured to record an image included in a captured video data in association with an event having occurred in an image capturing period, an identification unit configured to identify an image associated with a predetermined type of event among a plurality of images recorded in the recording unit, a generation unit configured to generate summary information to identify an image associated with the predetermined type of event, based on an identification result obtained by the identification unit, and a determination unit configured to determine an image to be deleted as an erasable part of a plurality of images recorded in the recording unit based on the summary information generated by the generation unit.

Further features of the present invention will become apparent from the following description of exemplary embodiments with reference to the attached drawings.

### BRIEF DESCRIPTION OF THE DRAWINGS

FIG. 1 illustrates a configuration of a recording control apparatus according to a first exemplary embodiment.

FIG. 2 illustrates an example of summary information.

FIG. 3 illustrates a deletion restricting range.

FIG. 4 illustrates a hierarchical structure of data recorded in a recording device.

FIG. 5A illustrates an example of layer3 hierarchy summary information.

FIG. 5B illustrates an example of layer2 hierarchy summary information.

FIG. 6 is a flowchart illustrating processing that can be performed by the recording control apparatus.

FIG. 7 is a flowchart illustrating data reduction processing.

FIG. 8 illustrates a configuration of a recording control apparatus according to a second exemplary embodiment.

FIG. 9 illustrates an example of a configuration of a recording control system.

FIG. 10 is a functional block diagram illustrating an analyzing unit.

FIG. 11 illustrates an example of a file configuration applied to a video file and a joint metadata file to be recorded in the recording device.

### DESCRIPTION OF THE EMBODIMENTS

Various exemplary embodiments, features, and aspects of the invention will be described in detail below with reference to the drawings.

A configuration described in each exemplary embodiment is a mere example and the present invention is not limited to the illustrated configuration.

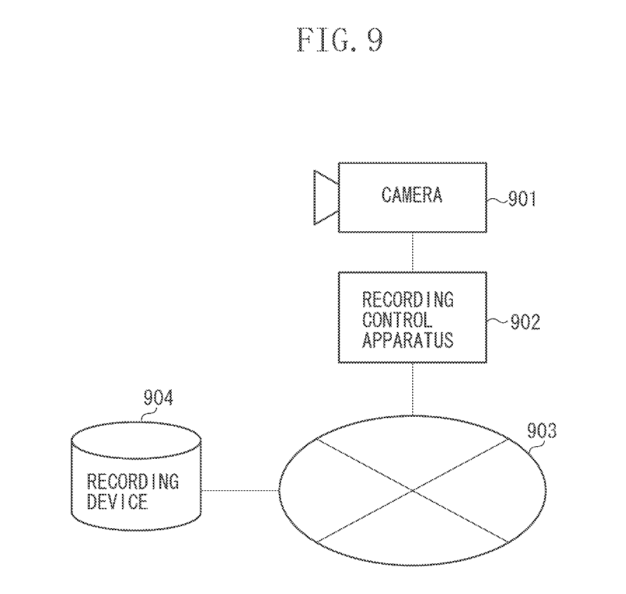

A configuration of a video recording system according to the first exemplary embodiment is described with reference to FIG. 9. The video recording system illustrated in FIG. 9 includes a camera 901 connected to a recording control apparatus 902. Further, the recording control apparatus 902 is connected to a recording device 904 via a network 903. The camera 901 and the recording control apparatus 902 can be configured to be connected via the network 903.

The camera 901 and the recording control apparatus 902 can be integrally formed. Alternatively, the recording control apparatus 902 and the recording device 904 can be integrally formed and the recording control apparatus 902 can be connected to the camera 901 via the network 903.

The camera 901 is an imaging apparatus. The camera 901 transmits captured images to the recording control apparatus 902.

The recording control apparatus 902 acquires each captured image, when the camera 901 transmits the captured image, and causes the recording device 904 to record a plurality of captured images. In the present exemplary embodiment, the camera 901 transmits captured images to the recording control apparatus 902 although the system configuration is not limited to the illustrated example. If there is a third apparatus that can hold images captured by the camera 901, the third apparatus can transmit image data to the recording control apparatus 902.

The recording device 904 can record images captured by the camera 901 and metadata generated by the recording control apparatus 902, under the control of the recording control apparatus 902. The recording device 904 is, for example, a network attached storage (NAS), an SD card, or a hard disk drive, which is capable of recording various data appropriately. The recording device 904 is not limited to a specific device.

The network 903 can be constituted by a wired local area network (LAN), a wireless LAN, or a wide area network (WAN). The network 903 is, for example, the internet. The network 903 is not specifically limited in communications standards, scale, and configuration. For example, when the network is constituted by a LAN, Ethernet (registered trademark) is the communications standards usable for the LAN.

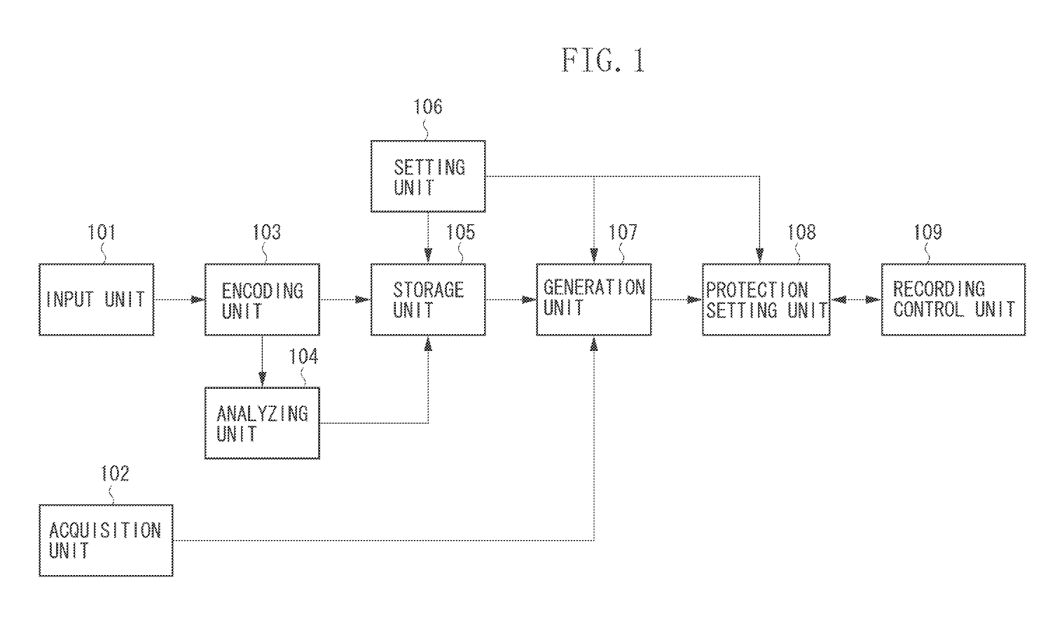

Next, a configuration of the recording control apparatus 902 according to the present exemplary embodiment is described with reference to FIG. 1. An input unit 101 is configured to input video data to the recording control apparatus 902. The input unit 101 can allocate image ID to each of a plurality of images (hereinafter, referred to as “frames”) that constitute the input video data. The image ID is identification information that identifies each acquired frame.

In the present exemplary embodiment, the input unit 101 acquires video data from the camera 901 and transmits the acquired video data to the recording control apparatus 902, although the system configuration is not limited to the illustrated example. For example, if there is a third apparatus that can hold video data captured by the camera 901, the input unit 101 can acquire the video data from the third apparatus. Alternatively, the input unit 101 can acquire video data from a built-in memory or a storage unit of the recording control apparatus 902.

An acquisition unit 102 is configured to acquire camera control information from the camera 901. For example, the camera control information includes information relating to camera imaging range. For example, the information relating to the camera imaging range includes information about pan, tilt, and zoom of the camera. Further, for example, the camera control information can include setting information about white balance and exposure change of the camera. As mentioned above, the acquisition unit 102 can acquire control information indicating contents of controls to be performed for the camera (i.e., the imaging apparatus) that can capture a plurality of images.

In a case where the camera control information is described in a header portion of frame image data acquired by the input unit 101, the acquisition unit 102 can acquire the camera control information with reference to information of the header portion.

An encoding unit 103 is configured to encode each frame image data acquired by the input unit 101 and generate an encoded image. In the present exemplary embodiment, for example, the encoding unit 103 can encode each frame acquired by the input unit 101 using the H.264/MPEG-4 AVC (hereinafter, referred to as “H.264”) method. Further, the encoding unit 103 can generate a gray image based on only luminance components extracted from each acquired frame image data.

The method to be used in the encoding processing performed by the encoding unit 103 is not limited to the H.264 method. For example, a high efficiency video coding encoding method (hereinafter, referred to as “HEVC”) can be used. Further, an encoding method (e.g., a continuous JPEG method or an MPEG-2 method) can be used to encode continuous images.

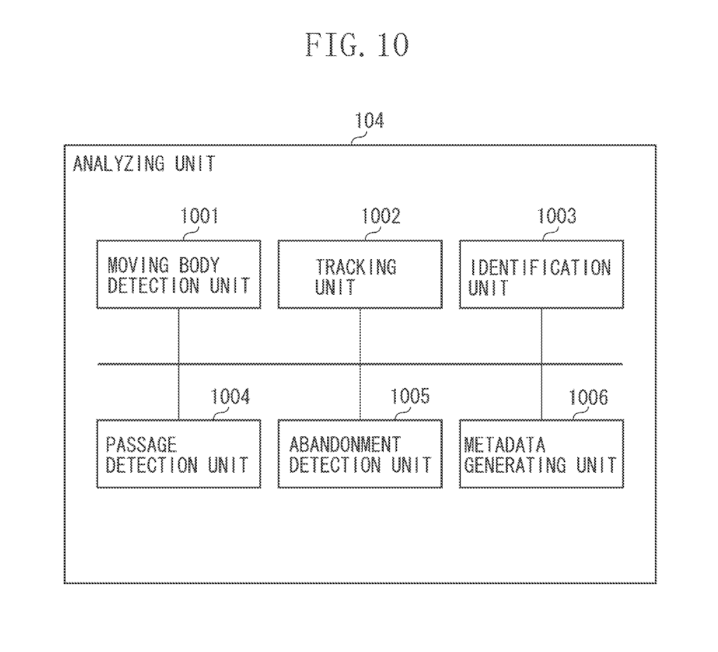

An analyzing unit 104 is configured to perform image analysis on a plurality of frames that constitute video data input via the input unit 101. FIG. 10 illustrates a configuration of the analyzing unit 104 according to the present exemplary embodiment.

A moving body detection unit 1001 is configured to perform processing for detecting a moving body from video data constituted by a plurality of frames acquired by the input unit 101. The moving body detection unit 1001 according to the present exemplary embodiment can detect a moving body from a gray image generated by the encoding unit 103. Instead of using the gray image, it may be useful to detect a moving body by directly using image data of a frame acquired by the input unit 101. For example, it is useful to detect a moving body using a background difference method or an inter-frame difference method.

A tracking unit 1002 is configured to perform processing for tracking a moving body detected by the moving body detection unit 1001. For example, the tracking unit 1002 determines whether the detected moving body in a frame is the same as that in another frame by comparing positions of the detected moving bodies between two or more frames and allocates unique identification information to the detected same moving body. The moving body tracking method is not limited to the above-mentioned method for comparing the positions of the moving body between frames. For example, it is useful to use an optical flow.

An identification unit 1003 is configured to determine whether an object included in a frame is a specific object. For example, the identification unit 1003 can determine whether an object having a specific shape is included in the frame by comparing an image of a frame with a predetermined pattern image having a specific shape (e.g., human shape). For example, the attribute that can be allocated to the specific object is human, animal, or the like. The human attribute can be discriminated between male and female.

The identification unit 1003 according to the present exemplary embodiment can determine whether the moving body is the specific object based on respective patterns of shape feature and behavior feature of each moving body to which identification information is allocated.

A passage detection unit 1004 is configured to perform passage detection processing for detecting a tracking moving body has passed a specific area or line on a frame image.

An abandonment detection unit 1005 is configured to perform abandonment detection processing for determining whether a predetermined object has stayed in the same area of a frame image for a predetermined time.

A metadata generating unit 1006 is configured to generate metadata for each frame based on an image analysis result obtained by the analyzing unit 104. For example, the metadata includes moving body identification information, moving body locus, object identification result, passage detection result, and abandonment detection result. Further, the metadata generated by the metadata generating unit 1006 includes a description relating to its own data size. For example, data size information can be written in a header portion of the metadata.

The processing to be performed by the analyzing unit 104 is not limited to the above-mentioned example and can be any other processing employable to analyze an image and generate metadata. Hereinafter, each event detected by the analyzing unit 104 based on video data analysis is collectively referred to as a detection event. For example, the detection event includes a moving body detection event, a specific object detection event, a passage detection event, and an abandonment detection event. As mentioned above, the analyzing unit 104 can detect an occurrence of a predetermined event in a video constituted by a plurality of images (e.g., frames).

In FIG. 1, the storage unit 105 is configured to store encoded images encoded by the encoding unit 103. Further, the storage unit 105 can store metadata generated by the analyzing unit 104.

The encoded image and the metadata can be temporarily stored in the storage unit 105. A generation unit 107 is configured to generate a file of the stored encoded image and metadata as described below when the data amount of the encoded image and the metadata stored in the storage unit 105 reaches a predetermined amount. Then, a recording control unit 109 transmits the file generated by the generation unit 107 to the recording device 904. A setting unit 106 is configured to set the above-mentioned predetermined amount, as described below. If the encoded image and the metadata have been transmitted to the recording device 904, these data are deleted from the storage unit 105.

Further, the storage unit 105 can store frame image ID acquired by the input unit 101 in association with an encoded image generated by the encoding unit 103. Further, the storage unit 105 can store the frame image ID acquired by the input unit 101 in association with metadata generated by the analyzing unit 104 for each frame.

The setting unit 106 can hold various settings to be used when the recording control apparatus 902 performs a storage control. The setting unit 106 can hold setting information relating to a threshold value with respect to the data amount of the encoded image and the metadata stored in the storage unit 105. When the data amount of the encoded image and the metadata stored in the storage unit 105 reaches the threshold value, a file is generated by the generation unit 107 based on the stored encoded image and metadata and transmitted to the recording device 904.

Further, the setting unit 106 can hold setting information to be used when the recording control apparatus 902 causes the recording device 904 to record a file. The file to be recorded in the recording device 904 is a file that can be generated by the generation unit 107 based on the encoded image and the metadata stored in the storage unit 105.

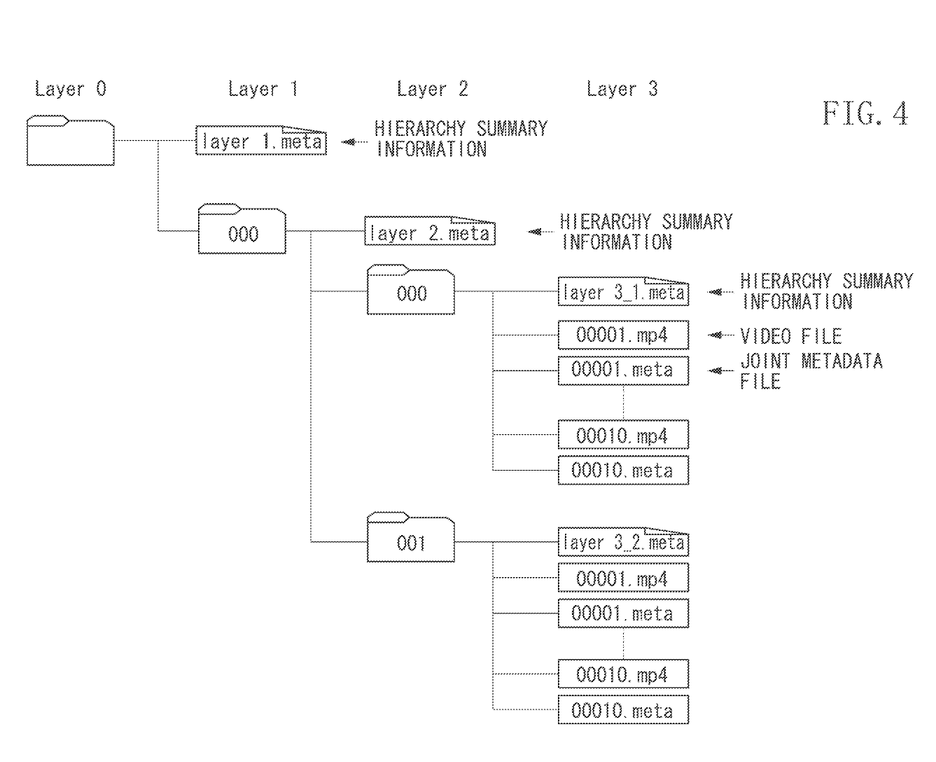

The recording control apparatus 902 causes the recording device 904 to record files to form a hierarchical structure, as illustrated in FIG. 4. The setting unit 106 can hold setting information about the number of files that can be stored in one directory (hereinafter, referred to as “folder”) that constitutes a part of the hierarchical structure. The number of files that can be stored in one folder can be set for each hierarchy of the hierarchical structure. Hereinafter, the number of files that can be stored in a folder is referred to as the hierarchy setting number.

According to the example illustrated in FIG. 4, each folder 000 that belongs to the hierarchy of Layer 2 can store 20 files (e.g., mp4 files and meta files). According to the example illustrated in FIG. 4, the hierarchy setting number is 20. According to the example illustrated in FIG. 4, a video file (i.e., an mp4 file) and a joint metadata file (i.e., a meta file) are recorded to have a one-to-one relationship.

The video file is a data file that can be generated by the generation unit 107 as described below, based on a plurality of encoded images stored in the storage unit 105.

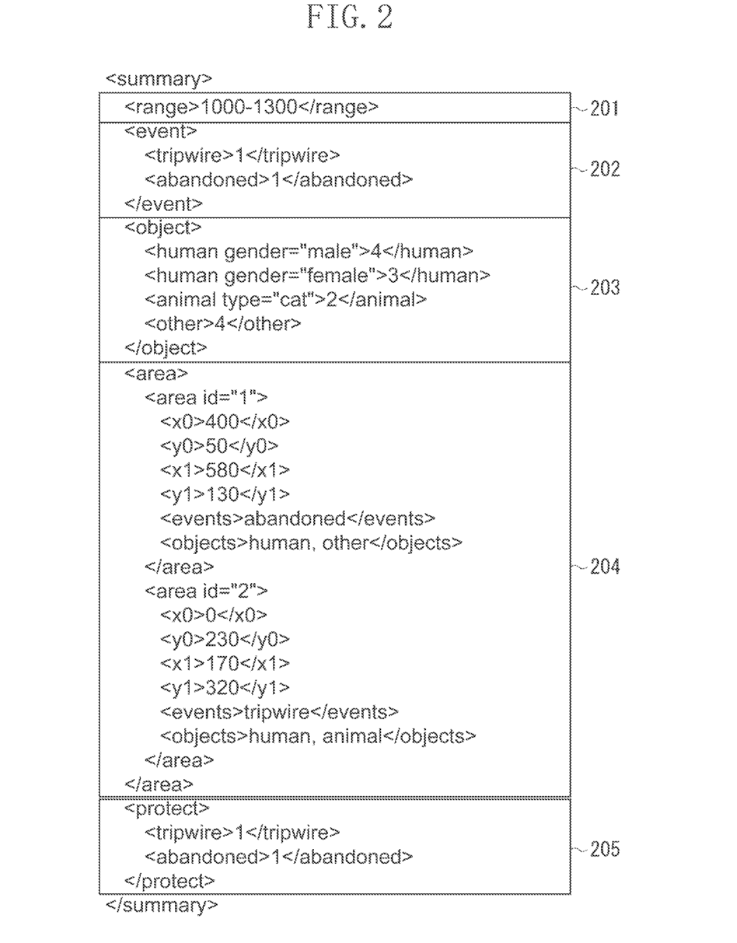

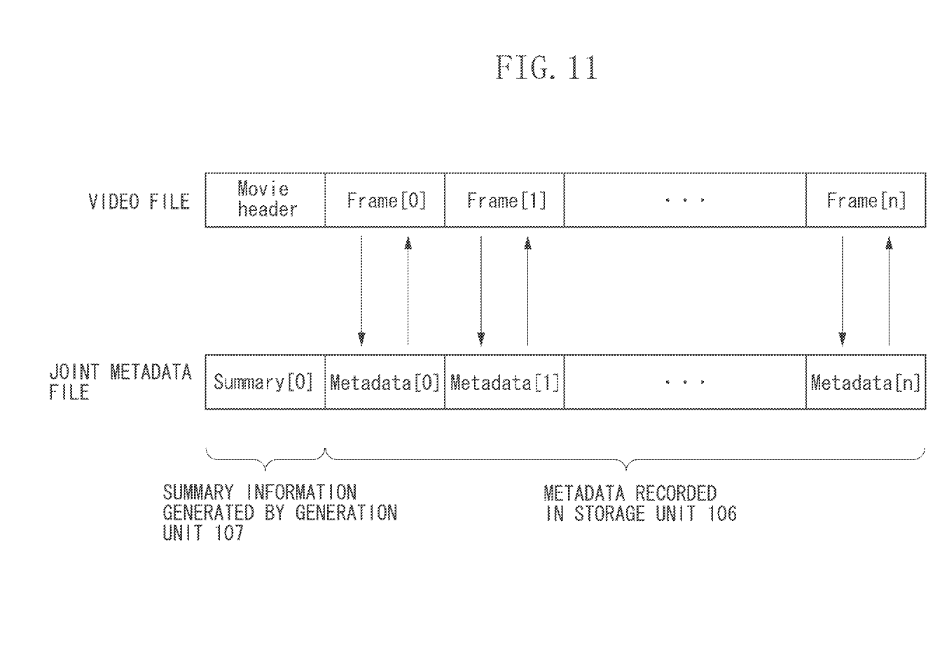

The joint metadata file is a metadata file including summary information joined with the metadata stored in the storage unit 105. The summary information can be generated by the generation unit 107 based on the metadata stored in the storage unit 105, as described in detail below with reference to FIG. 2. Further, the joint metadata file is described in detail below with reference to FIG. 11.

The folder 000 that belongs to the hierarchy of Layer 2 illustrated in FIG. 4 can store ten joint metadata files together with ten video files.

If the number of files stored in a folder reaches the hierarchy setting number, the generation unit 107 generates hierarchy summary information about the files stored in the folder.

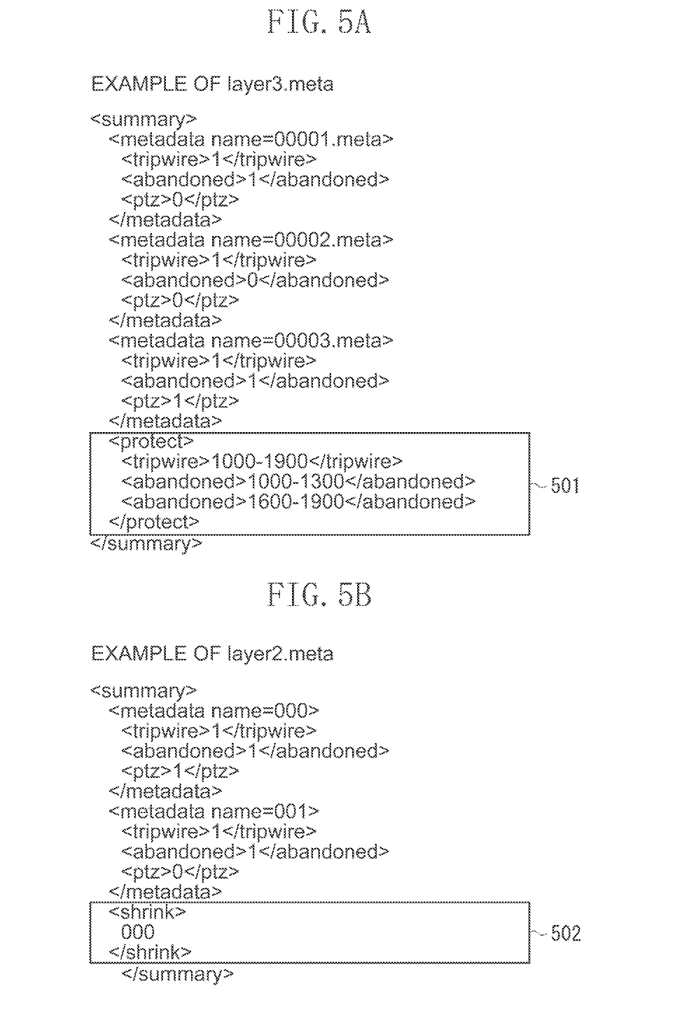

The hierarchy summary information is information about the detection event in video data constituted by a plurality of files stored in a folder and information about protection information relating to the video data. The hierarchy summary information is described in detail below with reference to FIGS. 5A and 5B. A file of the generated hierarchy summary information can be stored in a folder corresponding to the content of the hierarchy summary information.

Further, if the file number of files stored in a folder reaches the hierarchy setting number, the generation unit 107 generates a new folder.

The setting unit 106 illustrated in FIG. 1 holds a setting of a summary filter that designates the descriptive content of the summary information. The summary information is information about the detection event in one video file and information about protection information relating to video data of the video file. The protection information is information which indicates protection of a part or the whole of the video data of the video file from deletion.

In the present exemplary embodiment, a user of the recording control apparatus 902 can determine the setting contents to be held in the setting unit 106. For example, although not illustrated, the user operates a personal computer (PC) or a tablet terminal that is connected to the recording control apparatus 902 via the network 903 to determine the setting contents to be held in the setting unit 106.

The generation unit 107 can generate video files using encoded images stored in the storage unit 105. Further, the generation unit 107 can generate summary information about each video file based on the metadata generated by the analyzing unit 104. The video file summary information is described in detail below with reference to FIG. 2.

Further, the generation unit 107 can generate joint metadata files based on the generated summary information and metadata generated by a metadata generation unit of the analyzing unit 104. One joint metadata can be generated for a single video file. The joint metadata is described in detail below with reference to FIG. 11.

Further, the generation unit 107 can generate hierarchy summary information based on the summary information of each video file. The hierarchy summary information can be generated based on a plurality of pieces of joint metadata relating to a plurality of video files. The hierarchy summary information is described in detail below with reference to FIGS. 5A and 5B.

The summary information of each video file is metadata including protection information that indicates whether deleting a corresponding video file from the recording device 904 is restricted. For example, the summary information includes protection information indicating that deleting an image that constitutes a video in which a predetermined event has occurred is restricted.

Further, the hierarchy summary information is metadata that identifies an image to be restricted from being deleted from the recording device 904 as a part of a plurality of images recorded in the recording device. For example, the hierarchy summary information indicates a video file to be restricted from being deleted from the recording device 904 as a part of the plurality of video files recorded in the recording device.

In the present exemplary embodiment, the video file that can be generated by the generation unit 107 is a file having been compressed and coded according to the MP4 (ISO/IEC 14496-14:2003) method. The generation unit 107 can set the size and the offset position of each encoded image as information required for an MP4 file structure. A file format of the video file that can be generated by the generation unit 107 is not limited to MP4. Any other format, such as audio video interleave (AVI), is employable if the encoded image can be constituted as one video.

In the present exemplary embodiment, the summary information that can be generated by the generation unit 107 includes information about the range of stored metadata, the number of events, and the number of objects, in addition to object position information and control information about the camera 901. The generation unit 107 can generate summary information according to the settings of a summary information filter held by the setting unit 106.

FIG. 2 illustrates an example of the summary information that is described according to the extensible markup language (XML) method. The description of the summary information to be generated by the generation unit 107 is not limited to the XML method. For example, a binary method or any other original method is employable.

According to the example illustrated in FIG. 2, the summary information filter includes a description relating to metadata range 201, number of events 202, number of objects 203, and object position information 204.

The metadata range 201 indicates a data range that corresponds to the descriptive content of the summary information. According to the example illustrated in FIG. 2, the metadata range 201 is expressed using the image ID allocated by the input unit 101. When the metadata range 201 is 1000-1300, it indicates that the summary information is related to video data composed of sequential frames ranging from a frame (image ID=1000) to a frame (image ID=1300).

The number of events 202 indicates the number of detection events (events) in the metadata range 201. According to the example illustrated in FIG. 2, the number of events 202 indicates that the number of passage detection events (see <tripwire>) is 1 and the number of abandonment events (see <abandoned>) is 1.

The number of objects 203 indicates the number of objects detected from the video data (see <object>). The object is, for example, a moving body detected by the moving body detection unit 1001 or a specific body identified by the identification unit 1003.

According to the example illustrated in FIG. 2, the number of objects 203 indicates the number of the specific objects identified by the identification unit 1003 for each attribute. The number of objects 203 illustrated in FIG. 2 indicates that four male humans (see <human gender=“male”>) and three female humans (see <human gender=“female”>) have been detected. Further, the number of objects 203 illustrated in FIG. 2 indicates that two cats (see <animal type=“cat”>) and four other objects (see <other>) have been detected. The number of objects is not limited to the example illustrated in FIG. 2. For example, it is useful to indicate the number of detected moving bodies.

The position information 204 indicates an area of a screen in which the object has been detected (see <are>). For example, the position information 204 indicates an area that involves respective positions of a plurality of detected objects.

The position information 204 illustrated in FIG. 2 includes a description of the position information about two areas. According to the example illustrated in FIG. 2, each area included in one frame is represented using an x-coordinate value and a y-coordinate value although the position of the origin is not specifically mentioned in the coordinate system.

According to the example illustrated in FIG. 2, the position information 204 indicates that a first area is in a range from 400 to 580 with respect to the x-coordinate value and is in a range from 50 to 130 with respect to the y-coordinate value. Further, the position information 204 indicates that an abandonment detection event has occurred in the first area. Further, the position information 204 indicates that a human and other object have been detected in the first area.

Further, according to the example illustrated in FIG. 2, the position information 204 indicates that a second area is in a range from 0 to 170 with respect to the x-coordinate value and is in a range from 230 to 320 with respect to the y-coordinate value. The position information 204 indicates that a passage detection (see “tripwire”) event has occurred in the second area. Further, the position information 204 indicates that a human and an animal have been detected in the second area.

A protection range 205 indicates whether to restrict the data (e.g. frame) of the metadata range 201 from being deleted, when the recording control apparatus 902 performs processing for deleting the data recorded in the recording device 904. For example, when the numerical value recorded in the protection range 205 is 0, the data in the range indicated by the metadata range 201 can be deleted when the recording control apparatus 902 performs the deletion processing. When the numerical value recorded in the protection range 205 is 1, deleting the data in the range indicated by the metadata range 201 is restricted. Further, it is useful to add a description indicating the reason why the deletion is restricted. For example, the reason can be added as information about an occurrence of a predetermined event in the range indicated by the metadata range 201.

For example, restricting the data of a scene in which a passage detection event <tripwire> or an abandonment detection event (abandoned) has occurred from being deleted during the deletion processing may be set beforehand, as described in detail below. A protection setting unit 108 is configured to set the setting information, as described below. According to the example illustrated in FIG. 2, the occurrence of the passage detection event and the abandonment detection event can be recognized in the frame range from image ID 1000 to image ID 1300. Therefore, a description of the protection range 205 includes identification information about restricting the frames in the frame range from image ID 1000 to image ID 1300 from being deleted even in the deletion processing because of the occurrence of the passage detection event.

For example, the description of the protection range 205 includes <tripwire>1</tripwire>. Similarly, the description of the protection range 205 includes identification information about restricting the frames in the frame range from image ID 1000 to image ID 1300 from being deleted even in the deletion processing because of the occurrence of the abandonment detection event. For example, the description of the protection range 205 includes <abandoned>1</abandoned>.

As mentioned above, for example, it is feasible to prohibit the video data constituted by the frames of image ID 1000 to image ID 1300 from being deleted or overwritten by other data.

The descriptive content in the summary information is not limited to the above-mentioned example. Further, the descriptive content in the summary information may not include all of the above-mentioned content. The summary information can be any intensive content of the metadata recorded in the range indicated by the metadata range 201.

The protection setting unit 108 performs a control to set data to be restricted from being deleted. The setting performed by the protection setting unit 108 is, for example, restricting a frame from being deleted if the frame is in a range in which a detection event (e.g., a moving body detection event, a specific object detection event, an abandonment detection event, or a passage detection event) has occurred. As mentioned above, when a free space of the recording device 904 is insufficient, the protection setting unit 108 can prevent the specific data in the detection event occurrence range from being deleted.

It is useful to enable a user to instruct the protection setting unit 108 about the data to be restricted from being deleted. For example, the user operates a PC (not illustrated) or a tablet terminal that is connected to the recording control apparatus 902 via the network 903 to instruct contents of settings to be performed by the protection setting unit 108. For example, the user can instruct whether to designate data associated with a detection event (e.g., a moving body detection event, a specific object detection event, an abandonment detection event, or a passage detection event) as a protection target, and cause the protection setting unit 108 to perform settings for the protection target.

The following is the contents that can be set by the protection setting unit 108. For example, it is now presumed that the moving body detection unit 1001 detects an appearance of a first moving body at a first time and the tracking unit 1002 starts tracking the moving body at the first time. It is further presumed that the moving body disappears at a second time later than the first time, as described in detail below. Furthermore, it is presumed that the identification unit 1003 identifies the moving body to be tracked as a specific object (e.g., a human) at a third time later than the first time and earlier than the second time.

Further, it is presumed that the protection setting unit 108 sets video data in which a moving body detection event has occurred as data to be restricted from being deleted. In this case, the data to be restricted from being deleted can be data including a period from the first time to the second time (i.e., the time when the detected moving body disappears from the video data). As mentioned above, the protection setting unit 108 can set the data in the moving body detected period as the data to be restricted from being deleted.

Alternatively, it can be presumed that the protection setting unit 108 sets video data in which a human is present as data to be restricted from being deleted. In this case, if the identification unit 1003 identifies the tracking target (i.e., the first moving body) as a specific object (e.g., a human), a time preceding the first time (at which the tracking unit 1002 has started tracking the first moving body) can be set as a start time of a deletion restricting period. Further, a time following the second time (at which the first moving body disappears from the video data) can be set as an end time of the deletion restricting period.

As mentioned above, when the moving body to be tracked can be identified as a specific object, the data including the period from the first time to the second time can be restricted from being deleted. For example, when a moving body in the video data is detected as a human, video data including the period starting when the human appears and ending when the human disappears can be restricted from being deleted.

As mentioned above, a limited length of video data including a specific period in which a specific object is present can be restricted from being deleted. Further, it is feasible to set a data deletion restricting period retroactively in such a manner that the period starts at a time earlier than the moving body tracking start timing. In the present exemplary embodiment, the specific object is an object having a specific feature quantity. The feature quantity is, for example, shape, color, or size of the object.

In addition, the protection setting unit 108 can set a frame deletion restricting period based on control information (e.g., focus and/or zoom values and imaging direction) about the camera 901.

Further, the protection setting unit 108 can be configured to associate a priority level with data when the recording control apparatus 902 causes the recording device 904 to record the data. When the recording capacity of the recording device 904 is insufficient, the recording control apparatus 902 can overwrite the data associated with a first priority level by any other data associated with a second priority level, if the second priority level is higher than the first priority level.

For example, a priority level to be allocated to the data in a detection event occurrence range can be set to be higher than a priority level to be allocated to the data in a detection event non-occurrence range. Alternatively, it is feasible to allocate a priority level according to the type of each detection event. Further, the recording control apparatus 902 can be configured to overwrite data associated with a lower priority level by data associated with a higher priority level if the recording capacity of the recording device 904 is insufficient. In other words, the data associated with the lower priority level can be deleted from the recording device 904. As mentioned above, when the recording control apparatus 902 deletes a first image or a second image, the recording control apparatus 902 determines an image to be deleted between the first image and the second image with reference to the detected event type.

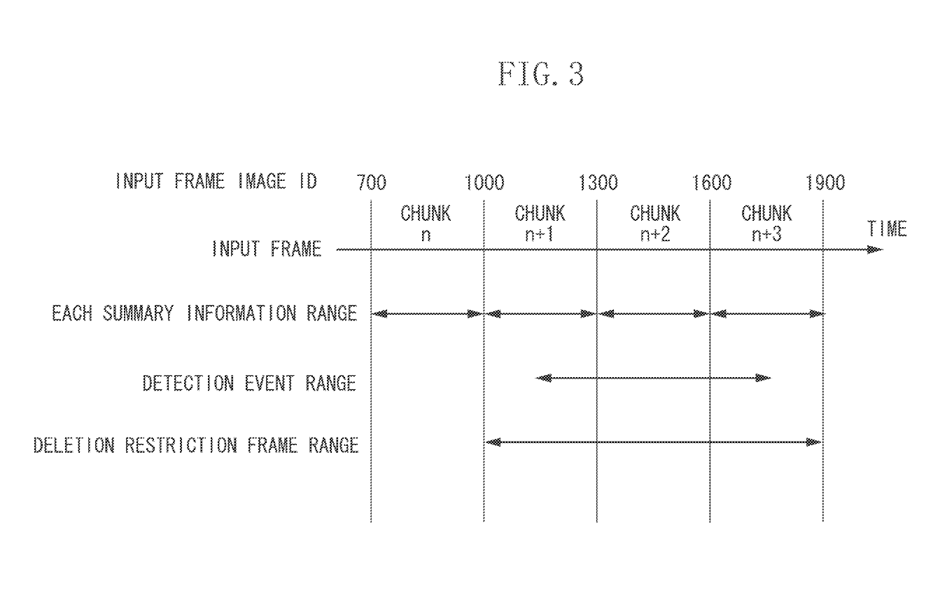

The protection setting unit 108 further determines a deletion restricting frame, which can be selected from the frames having the data stored in the storage unit 105, based on the setting value having been set by the protection setting unit 108. A method for determining the deletion restricting frame is described in detail below with reference to FIG. 3. In FIG. 3, an arrow of “input frame” indicates a plurality of frames continuously input to the recording control apparatus 902 via the input unit 101.

In the present exemplary embodiment, for the purpose of management, video data to be input to the recording control apparatus 902 is divided into a plurality of frame groups (hereinafter, each frame group is referred to as a “chunk”). For example, each chunk to be managed includes a predetermined number of frames. Alternatively, the video data can be divided into a plurality of chunks for each predetermined time. According to the example illustrated in FIG. 3, the input video data is composed of four chunks, i.e., chunk n, chunk n+1, chunk n+2, and chunk n+3. Each chunk includes a plurality of frames. According to the example illustrated in FIG. 3, the chunk n includes a plurality of frames whose frame image ID ranges from 700 to 999. The chunk n+1 includes a plurality of frames whose frame image ID ranges from 1000 to 1299. Further, according to the example illustrated in FIG. 3, the chunk n+2 includes a plurality of frames whose frame image ID ranges from 1300 to 1599. The chunk n+3 includes a plurality of frames whose frame image ID ranges from 1600 to 1899.

In the present exemplary embodiment, if there is not any change in setting values of the camera 901, the recording control apparatus 902 generates a bunch of summary information for each chunk. For example, a change (e.g., pan, tilt, or zoom) in the camera imaging range is a setting change of the camera 901.

If there is not any setting change in the camera 901, the recording control apparatus 902 generates the bunch of summary information that includes detection event information and video data protection information with respect to video data constituted by a plurality of frames included in one chunk.

According to the example illustrated in FIG. 2, information delimited using <summary>tag and </summary>tag is the bunch of summary information. According to the example illustrated in FIG. 2, the bunch of summary information includes the number of events 202, the number of objects 203, the position information 204, and the protection range 205.

According to the example illustrated in FIG. 3, the recording control apparatus 902 generates the bunch of summary information for the video data constituted by a plurality of frames included in the chunk n. Similarly, the recording control apparatus 902 generates the bunch of summary information for each of the remaining chunks (i.e., chunk n+1, chunk n+2, and chunk n+3).

If there is any setting change of the camera 901 in one chunk period, it is feasible to generate the divided bunch of summary information. For example, the recording control apparatus 902 can generate a bunch of summary information for video data including a frame captured before performing the setting change of the camera 901. Further, the recording control apparatus 902 can generate a bunch of summary information for video data including a frame captured after completing the setting change of the camera 901. As mentioned above, the generation unit 107 can generate summary information based on the control information of the camera 901.

In FIG. 3, an arrow of “detection event range” indicates a period during which a predetermined detection event set by the protection setting unit 108 has occurred. The example illustrated in FIG. 3 indicates that the predetermined detection event starts in the chunk n+1 period and ends in the chunk n+3 period. In the present exemplary embodiment, the predetermined detection event having been set by the protection setting unit 108 includes a setting that restricts video data in which the detection event has occurred from being deleted. For example, the predetermined detection event is any one of the moving body detection, the passage detection, the abandonment detection, or the specific object detection. Alternatively, as mentioned above, the detection event range can be a period in which at least one of the moving body detection event and the specific object detection event occurs for the same object.

In FIG. 3, an arrow of “deletion restriction frame range” indicates a range in which deletion of data is restricted. In the present exemplary embodiment, a data deletion restricting range is defined as the entire range of the chunk that includes the specific period in which the predetermined detection event set by the protection setting unit 108 has occurred. For example, according to the example illustrated in FIG. 3, the range from a start frame of the chunk n+1 to an end frame of the chunk n+3 is the deletion restricting range set by the protection setting unit 108. More specifically, the deletion restricting range can be set for each chunk.

The protection setting unit 108 describes information indicating that deleting the data in the range indicated by the summary information is restricted in the protection range 205 of the summary information corresponding to the deletion restriction frame range. According to the example illustrated in FIG. 3, the protection setting unit 108 describes information indicating the deletion restriction to be performed in the protection range 205 of the summary information corresponding to the chunk n+1 range. Similarly, the protection setting unit 108 describes information indicating that the deletion restriction to be performed in the protection range 205 of each summary information corresponding to the chunk n+2 range and the chunk n+3 range.

The recording control unit 109 performs a control to cause the recording device 904 to record the data (e.g., encoded image, hierarchy summary information, and joint metadata) stored in the storage unit 105. In this case, the data recorded in the recording device 904 has a hierarchical structure composed of video data generated from encoded images, hierarchy summary information, and joint metadata. The hierarchy summary information is described in detail below with reference to FIGS. 5A and 5B. Further, the joint metadata is described in detail below with reference to FIG. 11.

FIG. 4 illustrates an example of the hierarchical structure composed of video data generated from encoded images, hierarchy summary information, and joint metadata. The hierarchical structure illustrated in FIG. 4 includes a plurality of files classified into four hierarchies (i.e., from Layer 0 to Layer 3).

In the example illustrated in FIG. 4, a folder of Layer 0 is a route directory. A folder 000 of Layer 1 is a subdirectory of the route directory (i.e., the folder of Layer 0). A folder 000 and a folder 001 of Layer 2 are subdirectories of the folder 000 (i.e., a first directory) of Layer 1. The folder 000 of Layer 2 (i.e., a first subdirectory) includes a plurality of video files, related joint metadata files, and a hierarchy summary information file. Similarly, the folder 001 of Layer 2 (i.e., a second subdirectory) includes a plurality of video files, related joint metadata files, and a hierarchy summary information file.

In FIG. 4, mp4 files (see 00001.mp4 to 00010.mp4) are files of video data generated from a plurality of encoded images. In the present exemplary embodiment, it is presumed that only one video data file can be generated for each chunk described with reference to FIG. 3. Accordingly, when the chunk n is included in a certain video data file (e.g., a certain mp4 file), the chunk n+1 is included in another video data file (e.g., another mp4 file).

In FIG. 4, meta files (see 00001.meta to 00010.meta) are joint metadata files.

In FIG. 4, a layer 1.meta file, a layer 2.meta file, a layer3_{—}1.meta file, and a layer3_{—}2.meta file are hierarchy summary information files.

The joint metadata is a connection of the metadata stored in the storage unit 105 and summary information generated by the generation unit 107 based on the metadata stored in the storage unit 105.

A relationship between a video file and a joint metadata file is described in detail below with reference to FIG. 11. FIG. 11 illustrates a file configuration of a video file recorded in the recording device 904 and a related joint metadata file. The illustrated video file (see an upper part of the drawing) includes a header having an MP4Box structure (i.e., Movie Header), which is followed by a plurality of encoded images (see Frame[0] to Frame[n]) that are continuously disposed. The illustrated joint metadata file includes summary information generated by the generation unit 107, which is positioned at a leading portion thereof and followed by a plurality of metadata stored in the storage unit 105 that are continuously disposed in association with corresponding encoded images of Frame[0] to Frame[n].

The video file and the joint metadata file in the structure illustrated in FIG. 11 have the same name, although different extensions are allocated to respective files. Therefore, each video file can be correlated with a corresponding joint metadata. Further, when a joint metadata file is stored, hierarchy summary information is generated and updated. However, it is not always necessary to use the same file for the summary information and the metadata stored in the storage unit 105. When the summary information is stored in a certain file, the metadata stored in the storage unit 105 can be stored in another file.

Further, the hierarchy summary information is metadata that can be intensively generated based on joint metadata files in the same folder. The hierarchy summary information can be generated in such a manner that only one hierarchy summary information file is present in each folder.

For example, the layer3_{'}1.meta file and the layer3_{—}2.meta file (i.e., hierarchy summary information about Layer 3) can be generated in such a way as to be included in each folder of Layer 2.

For example, the layer31.meta file to be recorded in the folder 000 of Layer 2 includes information usable to identify a video file to be restricted from being deleted among video files included in the folder 000 of Layer 2. As mentioned above, the second metadata (hierarchy summary information) to be recorded in the first subdirectory includes information usable to identify a video file to be restricted from being deleted among video files included in the first subdirectory.

Further, the layer3_{—}2.meta file to be recorded in the folder 001 of Layer 2 includes information usable to identify a video file to be restricted from being deleted among video files included in the folder 001 of Layer 2. As mentioned above, the third metadata (hierarchy summary information) to be recorded in the second subdirectory includes information usable to identify a video file to be restricted from being deleted among video files included in the second subdirectory.

Further, the layer 2.meta file (i.e., hierarchy summary information about Layer 2) can be generated in such a way as to be included in each folder of Layer 1.

For example, the folder 000 (i.e., the first directory) of Layer 1 includes the layer 2.meta file (i.e., first metadata) that is the hierarchy summary information. The above-mentioned file includes information usable to identify an erasable subdirectory (i.e., a subdirectory whose images can be deleted from the recording device 904) included in the folder 000 (i.e., the first directory) of Layer 1. The information usable to identify an erasable subdirectory is described in detail below with reference to FIG. 5B.

Further, the above-mentioned file can include information usable to identify a video file to be restricted from being deleted among video files included in the folder 000 of Layer 2 or the folder 001 of Layer 2.

The generation unit 107 generates the layer 2.meta file (i.e., the first metadata) based on the layer3_{—}1.meta file (i.e., the second metadata) and the layer3_{—}2.meta file (i.e., the third metadata). The layer3_{—}1.meta file is hierarchy summary information in the folder 000 of Layer 2. Further, the layer32.meta file is hierarchy summary information in the folder 001 of Layer 2.

As mentioned above, the recording control unit 109 causes the first directory to record the first metadata that can identify an erasable subdirectory (i.e., a subdirectory whose images can be deleted from the recording device 904) included in the first directory. The first metadata is the layer 2.meta file (i.e., the hierarchy summary information). The information usable to identify a subdirectory that can be deleted from the recording device 904 is described in detail below with reference to FIG. 5B.

As only one folder is present in the Layer 0 (i.e., the upper hierarchy of Layer 1), only one hierarchy summary information about Layer 1 (i.e., the layer 1.meta file) is generated.

The hierarchy summary information is described in detail below with reference to FIGS. 5A and 5B. The hierarchy summary information illustrated in FIG. 5A is an example of the content the layer3_{—}1.meta file (i.e., the second metadata) that is the hierarchy summary information about Layer 3 illustrated in FIG. 4.

The hierarchy summary information about Layer 3 can be generated based on the summary information included in one folder of Layer 2. For example, the generation unit 107 generates the hierarchy summary information layer3.meta based on a plurality of pieces of joint metadata corresponding to a plurality of images (i.e., a plurality of video files) included in the folder 000 of Layer 2. The hierarchy summary information about Layer 3 includes an XML description about the number of detection events in the video data included in each folder of Layer 2 and the presence of an imaging range control of the camera 901.

For example, according to the example illustrated in FIG. 5A, information indicating that the passage detection event (tripwire) has once occurred and the abandonment event (abandoned) has once occurred can be extracted from the 00001.meta file. Further, information indicating that the imaging range control (ptz) of the camera 901 has not been performed can be extracted from the 00001.meta file. The above-mentioned information is described in the hierarchy summary information. Further, information indicating that the passage detection event has once occurred can be extracted from the 00002.meta file.

Further, information indicating that both the abandonment event and the imaging range control of the camera 901 have not occurred can be extracted from the 00002.meta file. The above-mentioned information is described in the hierarchy summary information. Further, information indicating that the passage detection event has once occurred, the abandonment event has once occurred, and the imaging range control of the camera 901 has been once performed can be extracted from the 00003.meta file. The above-mentioned information is described in the hierarchy summary information.

With respect to the video data in the folder, a plurality of video files constituted by the data ranging from the frame image ID 1000 to the frame image ID 1900 includes a passage detection event. The hierarchy summary information includes a description indicating that these video files are restricted from being deleted. The above-mentioned description of the hierarchy summary information is equivalent to restricting the chunk n+1, the chunk n+2, and the chunk n+3 illustrated in FIG. 3 from being deleted. Further, a plurality of video files composed of the data ranging from the frame image ID 1000 to the frame image ID 1300 includes an abandonment event.

The hierarchy summary information includes a description indicating that these video files are restricted from being deleted, which is equivalent to restricting the chunk n+1 illustrated in FIG. 3 from being deleted. Further, a plurality of video files constituted by the data ranging from the frame image ID 1600 to the frame image ID 1900 includes an abandonment detection event. The hierarchy summary information includes a description indicating that these video files are restricted from being deleted, which is equivalent to restricting the chunk n+3 illustrated in FIG. 3 from being deleted.

The hierarchy summary information illustrated in FIG. 5A includes a description relating to the data deletion restriction in the range of protection information 501.

Next, the hierarchy summary information (i.e., first metadata) about Layer 2 is described in detail below with reference to FIG. 5B. FIG. 5B illustrates an example of the content of the layer 2.meta file (i.e., the hierarchy summary information about Layer 2 illustrated in FIG. 4).

The hierarchy summary information about Layer 2 can be generated based on the hierarchy summary information about Layer 3 included in one folder of Layer 1 (i.e., the first directory). The hierarchy summary information about Layer 2 includes an XML description about the number of detection events in the video data included in each folder of Layer 2 and the presence of an imaging range control of the camera 901. Further, if the recording control unit 109 performs data reduction processing, a folder name of the data having been subjected to the reduction processing is described in the hierarchy summary information.

The recording control apparatus 902 determines whether each folder of Layer 2 includes an image that is restricted from being deleted from the recording device 904 based on the hierarchy summary information about Layer 2.

According to the example illustrated in FIG. 5B, a description ranging from <metadata name=000> to </metadata> indicates that a detection event has occurred in the video data included in the folder 000 (i.e., the first subdirectory) of Layer 2. The example illustrated in FIG. 5B indicates that a passage detection event, an abandonment detection event, and an imaging direction change event have occurred in the video data included in the folder 000 of Layer 2.

For example, restricting images of a scene from being deleted if a passage detection event or an abandonment detection event has occurred in the scene may be set beforehand. In this case, the recording control unit 109 of the recording control apparatus 902 can determine whether the folder 000 of Layer 2 includes an image that is restricted from being deleted from the recording device 904 with reference to the hierarchy summary information illustrated in FIG. 5B.

Similarly, according to the example illustrated in FIG. 5B, a description ranging from <metadata name=001> to </metadata> indicates that a detection event has occurred in the video data included in the folder 001 (i.e., the second subdirectory) of Layer 2. The example illustrated in FIG. 5B indicates that a passage detection event and an abandonment detection event have occurred in the video data included in the folder 001 of Layer 2.

For example, restricting images of a scene from being deleted if a passage detection event or an abandonment detection event has occurred in the scene may be set beforehand. In this case, the recording control unit 109 of the recording control apparatus 902 can determine whether the folder 001 of Layer 2 includes an image that is restricted from being deleted from the recording device 904 with reference to the hierarchy summary information illustrated in FIG. 5B.

Further, the recording control apparatus 902 can identify a folder having been subjected to the data reduction processing based on the hierarchy summary information about Layer 2.

As mentioned above, the hierarchy summary information (i.e., the first metadata) about Layer 2 is metadata that is usable to determine whether the first subdirectory includes an image that is restricted from being deleted from the recording device 904. Further, the hierarchy summary information about Layer 2 is metadata that is usable to determine whether the second subdirectory includes an image that is restricted from being deleted from the recording device 904. In FIG. 4, for example, the first subdirectory corresponds to the folder 000 of Layer 2 and the second subdirectory corresponds to the folder 001 of Layer 2.

The hierarchy summary information illustrated in FIG. 5B includes a description of reduction information 502 indicating that the folder 000 of Layer 2 has been subjected to the data reduction processing. In the present exemplary embodiment, the data reduction processing is processing to be performed to delete data which is not restricted from being deleted. However, if the free space of the recording device 904 is insufficient even after the deletion of the erasable data is completed, the data reduction processing can include processing for successively deleting the data that is once determined as data to be restricted from being deleted.

The recording control apparatus 902 can identify a folder that is not yet subjected to the reduction processing with reference to the reduction information 502 of the layer 2.meta file. More specifically, the recording control apparatus 902 can identify a subdirectory whose images can be deleted from the recording device 904 in the first directory (i.e., the folder 000 of Layer 1).

Next, processing that can be performed by the recording control unit 109 illustrated in FIG. 1 is described in detail below. First, the recording control unit 109 performs folder generation processing. For example, when the recording control unit 109 causes the recording device 904 to record a video file (e.g., an mp4 file) and a joint metadata file (e.g., a meta files), the recording control unit 109 generates folders of Layer 1 and Layer 2 one by one. Then, the recording control unit 109 records a video file and a joint metadata file in the undermost layer of Layer 3. According to the example illustrated in FIG. 4, the recording control unit 109 generates the folder 000 in the Layer 1. Further, the recording control unit 109 generates the folder 000 of Layer 2. Then, the recording control unit 109 records the video file and the joint metadata file in the folder 000 of Layer 2.

Further, the recording control unit 109 can record an additional file in the recording device 904, as described below. As mentioned above, the number of files recordable in each folder (i.e. the hierarchy setting number) can be set by the setting unit 106. In the present exemplary embodiment, it is presumed that each folder of Layer 2 can record ten video files and ten joint metadata files. In other words, the hierarchy setting number is 20.

In the present exemplary embodiment, the recording control unit 109 newly adds a video file and a joint metadata to a folder of Layer 2, which has a folder name whose numerical value is largest.

If the number of files stored in the file addition target folder reaches the hierarchy setting number, the recording control unit 109 generates a new folder that belongs to the Layer 2. In the present exemplary embodiment, the recording control unit 109 allocates a folder name of the new folder in such a way as to set a numerical value included in the folder name of the newly generated folder to be greater than any numerical value included in other folder name of the folder belonging to the Layer 2. The method of allocating the folder name is not limited to the above-mentioned example. Any other method is employable if it can determine a recording destination folder for a newly generated file.

In the present exemplary embodiment, the number of folders that can be generated in Layer 2 is 1000. For example, folder 000 to folder 999 can be generated in Layer 2.

If the number of folders generated in Layer 2 reaches an upper limit and it is necessary to generate a new folder, the recording control unit 109 generates a new folder of Layer 1. Then, the recording control unit 109 generates a folder 000 of Layer 2 that is subsidiary to the newly generated folder. In the same way, the recording control unit 109 repeats generating additional folders.

In the present exemplary embodiment, the number of folders that can be generated in Layer 1 is 1000. For example, folder 000 to folder 999 can be generated in Layer 1. If the number of folders generated in Layer 1 reaches an upper limit and it is necessary to record a file in the recording device 904, the recording control unit 109 reduces the data recorded in the recording device 904.

If the amount of the data recorded in the recording device 904 reaches a predetermined level, or if the available recording capacity of the recording device 904 becomes equal to or less than a predetermined amount, the recording control unit 109 can perform data reduction processing. In this case, the recording control unit 109 determines the amount of the data already recorded in the recording device 904. Alternatively, the recording control unit 109 can determine an amount of data that can be recorded in the recording device 904.

Next, a data deletion control that can be performed by the recording control unit 109 is described in detail below. When the recording control unit 109 performs data deletion processing, the recording control unit 109 generates a folder having a name “Shrink1” (i.e., a second directory) in the recording device 904. Further, the recording control unit 109 moves the folders of respective layers (i.e., Layer 0 and subsequent Layers) to the Shrink1folder. According to the example illustrated in FIG. 4, the recording control unit 109 moves the folder 000 of Layer 0 to the Shrink1 folder. Further, the recording control unit 109 moves the folder 000 of Layer 1 and the layer 1.meta file to the Shrink1 folder. Further, the recording control unit 109 moves the folder 000 and the folder 001 of Layer 2 and the layer 2.meta file to the Shrink1 folder. Further, the recording control unit 109 moves each file of Layer 3 to the Shrink1 folder.

Next, the recording control unit 109 refers to the hierarchy summary information included in the folder moved into the Shrink1 folder. The recording control unit 109 identifies a folder of Layer 2 that can be subjected to the reduction processing with reference to the hierarchy summary information about Layer 2 (layer 2.meta file). The folder to be subjected to the reduction processing is a folder whose data amount can be reduced by deleting erasable data contained in the folder.

For example, the recording control unit 109 refers to the reduction information 502 of the layer 2.meta file. The reduction information 502 includes a description of folders having been already subjected to the reduction processing. The recording control unit 109 identifies folders that are not yet subjected to the reduction processing with reference to the reduction information 502. Then, the recording control unit 109 designates a target folder to be first subjected to the reduction processing, which is one of the identified folders and has a smallest number. If the reduction information 502 does not include the description about the folders having been already subjected to the reduction processing, the recording control unit 109 designates the folder 000 as the target folder to be subjected to the reduction processing.

Next, the recording control unit 109 deletes the erasable data contained in the folder moved to the shrink1 folder with reference to the summary information stored in the folder to be subjected to the reduction processing.

For example, the hierarchy summary information illustrated in FIG. 5A indicates that the 00001.mp4 file corresponding to the metadata name=00001 includes a deletion restriction target (i.e., the occurrence of the passage detection event and the abandonment detection event).

Further, the 00002.mp4 file corresponding to the metadata name=00002 includes a deletion restriction target (i.e., the occurrence of the passage detection event).

Further, the 00003.mp4 file corresponding to the metadata name=00003 includes a deletion restriction target (i.e., the occurrence of the passage detection event and the abandonment detection event).

Therefore, the recording control unit 109 identifies files to be deleted, which are included in the folder 000 and other than the mp4 files and the meta files having file names 00001 to 00003. As mentioned above, the recording control unit 109 determines files to be subjected to the deletion processing. Then, the recording control unit 109 deletes the determined files.

Further, in a case where the priority order is allocated to each detection event according to the type of the detection event, the recording control unit 109 can prioritize deleting the data in the range associated with the detection event having a lower priority order. The recording control unit 109 continuously deletes the data until the available recording capacity of the recording device 904 reaches the predetermined amount.

For example, the analyzing unit 104 detects an occurrence of a first detection event having a higher priority order in a first period of the video. Further, the analyzing unit 104 detects an occurrence of a second detection event having a priority order lower than that of the first detection event in a second period of the video. The second detection event is different from the first detection event. For example, the first detection event is a passage detection event and the second detection event is an abandonment detection event. The generation unit 107 generates summary information indicating that the first detection event has occurred in the first period together with joint metadata including the summary information, based on an analysis result obtained by the analyzing unit 104. In this case, the summary information and the joint metadata indicate that an image constituting the video data of the period in which the first detection event has occurred is restricted from being deleted.

Further, the generation unit 107 generates summary information indicating that the second detection event has occurred in the second period and joint metadata including the summary information based on the analysis result of the analyzing unit 104. In this case, the summary information and the joint metadata indicate that an image constituting the video data of the period in which the second detection event has occurred is restricted from being deleted.

First, in a control to delete images from the recording device 904, the recording control unit 109 prioritizes deleting a third image that constitutes a video of a period that is not included in the first period and not included in the second period over deleting the first image and the second image.

Further, in the control to delete the images from the recording device 904, the recording control unit 109 prioritizes deleting the second image constituting the video of the second period over deleting the first image constituting the video of the first period, based on the summary information or the joint metadata generated by the generation unit 107.

When the recording control unit 109 completes the reduction processing for the files included in one folder of Layer 2, the recording control unit 109 describes a folder name of the folder having been subjected to the deletion processing in the hierarchy summary information about Layer 2. For example, according to the example illustrated in FIG. 4, if the recording control unit 109 completes the reduction processing for the files included in the folder 000 of Layer 2, the recording control unit 109 describes the folder name 000 (i.e., the name of the folder having been subjected to the deletion processing) in the layer 2.meta file (i.e., the hierarchy summary information). For example, as the reduction information 502 illustrated in FIG. 5B, the name of the deleted folder is described in the layer 2.meta file. Further, it is useful to describe the name of the deleted file (i.e., the file name of the file included in the folder 000 of Layer 2) in the hierarchy summary information about Layer 3. The reduction information 502 illustrated in FIG. 5B indicates that the folder 000 has been subjected to the reduction processing.

Similarly, the recording control unit 109 performs reduction processing for each folder of Layer 2 having moved to the shrink folder.

After completing the reduction processing on the folders of Layer 2, the recording control unit 109 newly generates folders of Layer 1 and Layer 2. Then, the recording control unit 109 records a new video data file and a new joint metadata file in Layer 3 (i.e., the undermost layer).

As mentioned above, the Shrink folder that stores only the files restricted from being deleted and the newly generated hierarchical data remain in the recording device 904 after the reduction processing has been completed.

If the free space of the recording device 904 becomes insufficient, the recording control unit 109 generates a folder having a name “Shrink2” and performs reduction processing similar to that performed for the Shrink1 folder.

The reduction processing is not limited to the above-mentioned example. Any other method capable of deleting erasable data (i.e., the data not included in the protection range) from the recording device 904 is employable.

For example, a range that can be obtained by excluding a data capacity of data restricted from being deleted from an actual recording capacity of the recording device 904 can be managed as an available recording capacity of the recording device 904. The available recording capacity of the recording device 904 can be used to determine whether the recording control unit 109 performs reduction processing for the recording device 904. As mentioned above, the recording control unit 109 determines the amount of data that can be recorded in the recording device 904 based on the joint summary information (i.e., metadata) indicating the data to be restricted from being deleted. Then, the recording control unit 109 performs a control to delete the image data recorded in the recording device if it is determined that the available recording capacity of the recording device 904 becomes less than the predetermined amount.

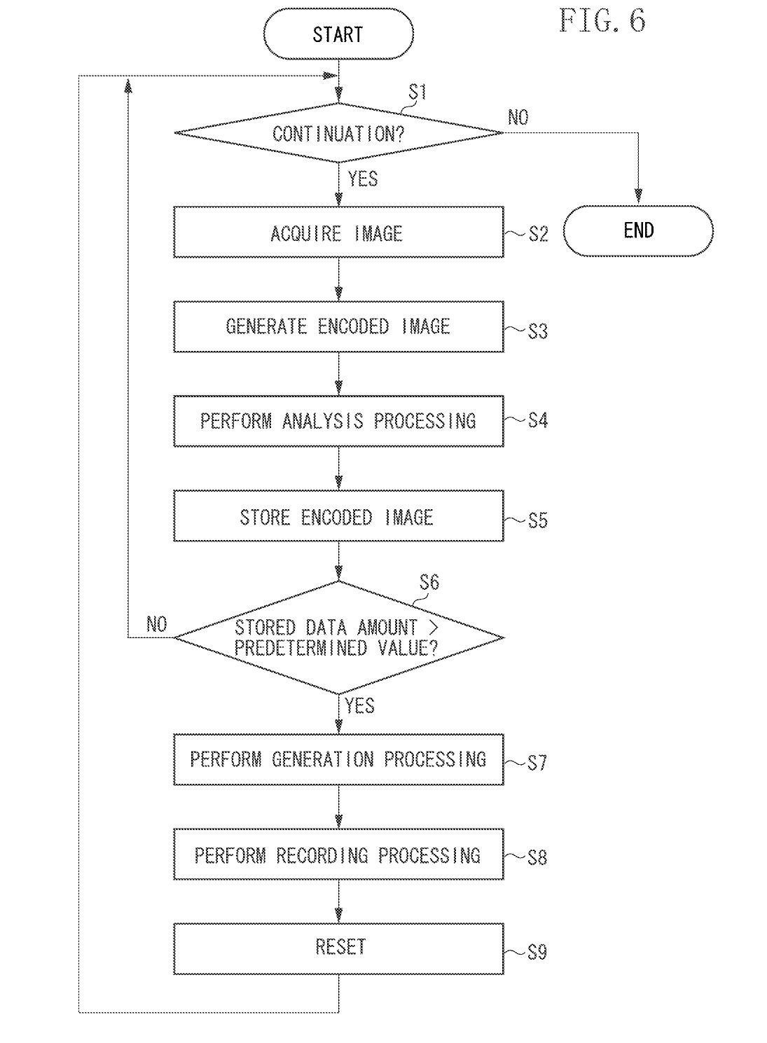

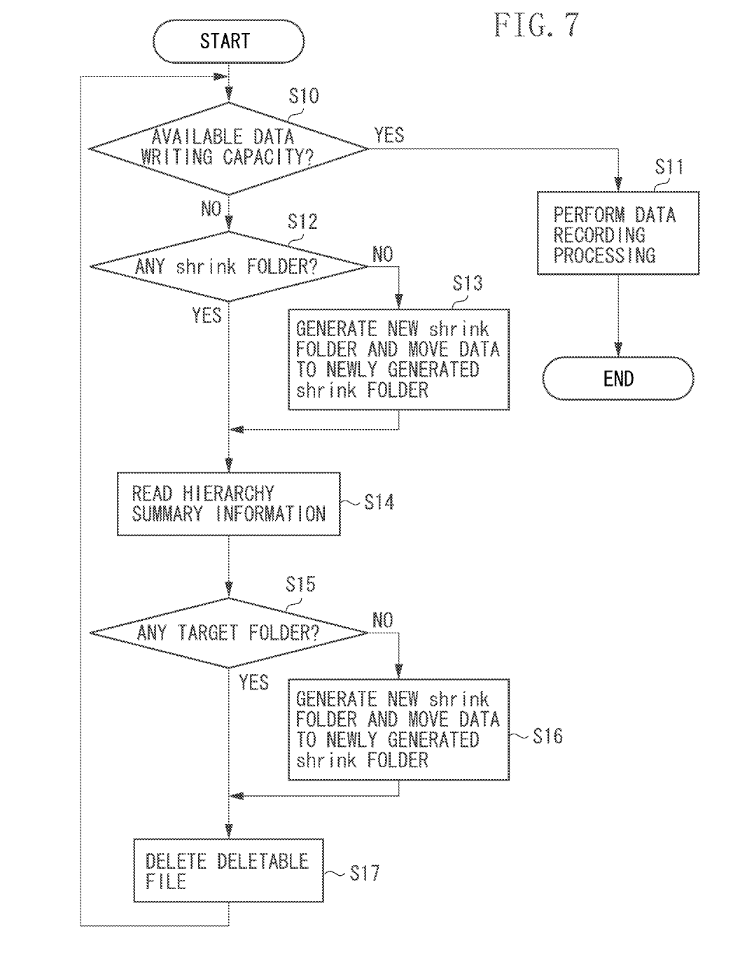

Next, processing that can be performed by the recording control apparatus 902 is described in detail below with reference to flowcharts illustrated in FIGS. 6 and 7. The constituent components of the recording control apparatus 902 illustrated in FIG. 1 cooperatively perform the processing illustrated in FIGS. 6 and 7, as described in detail below.

Alternatively, a processor incorporated in the recording control apparatus 902 can be configured to perform the processing illustrated in FIGS. 6 and 7. When the processor incorporated in the recording control apparatus 902 is available, the processing flows of FIGS. 6 and 7 indicate a software program that causes the processor to execute the procedure illustrated in FIGS. 6 and 7. The processor incorporated in the recording control apparatus 902 is a computer that can execute a program loaded from the storage unit incorporated in the recording control apparatus 902. A central processing unit (CPU) or a micro processing unit (MPU) is an example of the processor.

First, processing that can be performed by the recording control apparatus 902 is described in detail below with reference to FIG. 6. After recording processing is started, in step S1, the input unit 101 determines whether to continue the recording processing. For example, if the camera 901 continuously outputs video data, the input unit 101 can determine that the recording processing continues. On the other hand, if a predetermined time elapses since termination of the video data output from the camera 901, the input unit 101 can determine that the recording processing terminates. Further, if a user instructs to terminate the recording processing, the input unit 101 can determine that the recording processing terminates.

If it is determined that the recording processing continues (Yes in step S1), then in step S2, the input unit 101 acquires video data from the camera 901 and inputs the acquired video data to the recording control apparatus 902.

If the video data is input by the input unit 101, then in step S3, the encoding unit 103 generates an encoded image for each of frames that constitute the input video data.

Next, in step S4, the analyzing unit 104 performs analysis processing based on the encoded images. For example, the analysis processing includes moving body detection processing, tracking processing, specific object detection processing, passage detection processing, and abandonment detection processing. Further, the analyzing unit 104 generates metadata indicating an analysis result.

Next, in step S5, the storage unit 105 stores the encoded images generated by the encoding unit 103 and the metadata generated by the analyzing unit 104.

Further, in step S6, the storage unit 105 determines whether the amount of the data stored in the storage unit 105 has reached a setting value having been set by the setting unit 106. If it is determined that the amount of the data stored in the storage unit 105 is smaller than the setting value (No in step S6), the operation of the recording control apparatus 902 returns to step S1 to repeat the above-mentioned processing. On the other hand, if it is determined that the amount of the data stored in the storage unit 105 has reached the setting value (Yes in step S6), the operation proceeds to step S7.

If it is determined that the amount of the data stored in the storage unit 105 has reached the setting value (Yes in step S6), then in step S7, the generation unit 107 performs generation processing. More specifically, the generation unit 107 generates summary information based on the metadata stored in the storage unit 105. Further, the generation unit 107 generates hierarchy summary information based on the generated summary information. Further, the generation unit 107 generates joint metadata based on the summary information and the metadata indicating the analysis result obtained by the analyzing unit 104. Further, the generation unit 107 generates a video file based on the encoded image data stored in the storage unit 105.

In step S8, the recording control unit 109 performs recording processing for the recording device 904. The recording control unit 109 causes the recording device 904 to record the video file generated by the generation unit 107. Further, the recording control unit 109 causes the recording device 904 to record the joint metadata generated by the generation unit 107. Further, the recording control unit 109 records the hierarchy summary information indicating a data protection range in the recording device 904, so that the data in a protection range having been set by the protection setting unit 108 can be restricted from being deleted.

For example, the recording control unit 109 causes the first subdirectory (e.g., the folder 000 of Layer 2) included in the first directory (e.g., the folder 000 of Layer 1) of the recording device 904 to record a plurality of first images. Further, the recording control unit 109 causes the second subdirectory (e.g., the folder 001 of Layer 2) included in the first directory to record a plurality of second images. Then, the recording control unit 109 causes the first directory to record the first metadata usable to identify a subdirectory that can be deleted from the recording device 904, which is one of the images in the subdirectory included in the first directory. For example, the first metadata is the layer 2.meta file of the hierarchy summary information.

Further, the recording control unit 109 causes the first subdirectory to record the second metadata (e.g., hierarchy summary information “layer3_{—}1.meta”) usable to identify an image to be restricted from being deleted from the recording device 904 among the plurality of first images.

Further, the recording control unit 109 causes the second subdirectory to record the third metadata (e.g., hierarchy summary information “layer3_{—}2.meta”) usable to identify an image to be restricted from being deleted from the recording device 904 among the plurality of second images.

If the recording processing for the recording device 904 is completed, then in step S9, the storage unit 105 deletes the stored data. If the data stored in the storage unit 105 is deleted, the operation of the recording control apparatus 902 returns to step S1 to repeat the above-mentioned determination processing.

Next, the recording processing (step S8) described with reference to FIG. 6 is described in detail below with reference to FIG. 7. In the present exemplary embodiment, the recording control unit 109 performs the recording processing illustrated in FIG. 7, as described in detail below.

In step S10, the recording control unit 109 confirms whether a data writing capacity is equal to or greater than a predetermined amount with reference to a free space of the recording device 904.

If it is determined that the data writing capacity of the recording device 904 is equal to or greater than the predetermined amount (Yes in step S10), then in step S11, the recording control unit 109 writes the data into the recording control apparatus 902.

On the other hand, if it is determined that the data writing capacity is less than the predetermined amount (No in step S10), the recording control unit 109 searches for a data candidate that can be deleted with reference to the hierarchy summary information and the joint metadata recorded in the recording device 904.

First, in step S12, the recording control unit 109 determines whether a shrink folder is present in the recording device 904. The recording control unit 109 can confirm the presence of the shrink folder in the recording device 904 by referring to the hierarchy summary information recorded in the recording device 904. For example, the recording control unit 109 can determine that the shrink folder is present if a folder having been subjected to the reduction processing is included in the description of the reduction information 502 of the hierarchy summary information.

If it is determined that there is not any shrink folder generated in the recording device 904 (No in step S12), then in step S13, the recording control unit 109 newly generates a shrink folder and moves the data recorded in the recording device 904 to the newly generated shrink folder.

Next, in step S14, the recording control unit 109 reads the hierarchy summary information moved into the shrink folder. In step S15, the recording control unit 109 searches for a folder whose data can be deleted. The recording control unit 109 identifies a folder to be subjected to the reduction processing with reference to the reduction information 502 described in the hierarchy summary information. The folder to be subjected to the reduction processing is a folder whose data amount can be reduced by deleting a part of the data stored in the folder if it is not restricted from being deleted. In the present exemplary embodiment, a folder name of a folder having been already subjected to the reduction processing is described in the reduction information 502. Therefore, it is feasible to identify a folder not described in the reduction information 502 as a folder to be subjected to the reduction processing.

If there is not any folder to be subjected to the reduction processing (No in step S15), then in step S16, the recording control unit 109 newly generates a shrink folder. For example, when a description in the reduction information 502 indicates that the reduction processing has been completed for all folders stored in a shrink folder, it is feasible to determine that there is not any folder to be subjected to the reduction processing.

A folder name to be allocated to the newly generated shrink folder is differentiated from the names of existing shrink folders. For example, when a folder name “shrink1” is allocated to an initially created shrink folder, a new folder name “shrink2” can be allocated to the newly generated shrink folder. Further, in step S16, the recording control unit 109 moves the data recorded in the recording device 904 to the newly generated shrink2 folder.

Next, in step S17, the recording control unit 109 deletes erasable data in the folder, which is a part of the data moved to the shrink2 folder, with reference to the hierarchy summary information stored in the folder that is determined to be subjected to the reduction processing.

As mentioned above, when the recording control unit 109 deletes the images recorded in the recording device 904, the recording control unit 109 moves the first directory and its subdirectory recorded in the recording device 904 to the second directory (i.e., the shrink folder). Then, the recording control unit 109 performs a control to delete an erasable image (i.e., an image that is not restricted from being deleted), which is a part of the images included in the second directory, based on the hierarchy summary information stored in a folder that is determined to be subjected to the reduction processing. After completing the data deletion processing, the operation returns to step S10.

The method for reducing the data recorded in the recording device 904 is not limited to the above-mentioned example. Any other method is employable if it can perform the processing for reducing the amount of data recorded in the recording device 904 with reference to the metadata indicating the data to be restricted from being deleted as a part of the data recorded in the recording device 904.

According to the recording control apparatus 902 according to the present exemplary embodiment, even when the storage capacity of the recording device 904 is insufficient, the recording control apparatus 902 can continue the processing for recording images in the recording device 904 without losing specific images constituting an important scene.

The analyzing unit 104 of the recording control apparatus 902 described in the first exemplary embodiment analyzes input video data and generates metadata indicating an analysis result.

A recording control apparatus 902 according to a second exemplary embodiment is configured to acquire an analysis result of video data from an external apparatus, as described in detail below.

For example, the recording control apparatus 902 can be configured to receive metadata indicating an analysis result of the video data from the camera 901. Alternatively, the recording control apparatus 902 can be configured to receive an analysis result from an analyzing apparatus that can analyze the video data output from the camera 901.

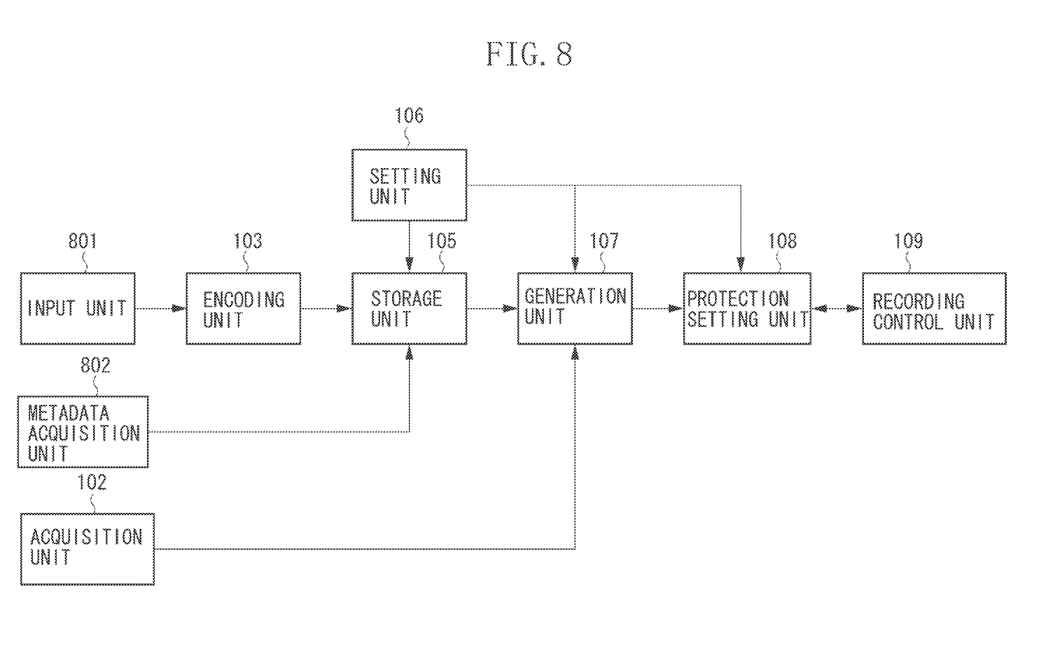

FIG. 8 illustrates a configuration of the recording control apparatus 902 according to the present exemplary embodiment.

An input unit 801 is configured to input video data to the recording control apparatus 902. The input unit 801 acquires an image ID that corresponds to a plurality of frames that constitutes the input video data. The image ID is identification information usable to identify each acquired frame.

A metadata acquisition unit 802 is configured to acquire metadata indicating that a predetermined event has occurred in the video data (hereinafter, referred to as “event information”). Further, the metadata acquisition unit 802 acquires a frame image ID corresponding to the acquired metadata. If there is not any frame that has an image ID corresponding to the metadata, the metadata acquisition unit 802 associates an image having a neighboring image ID with the metadata.

A generation unit 107 is configured to generate summary information indicating that an image constituting video data of a scene in which the predetermined event has occurred is restricted from being deleted and is configured to generate joint metadata including the summary information, based on the event information acquired by the metadata acquisition unit 802.

The remaining configuration is similar to that described in the first exemplary embodiment so that the recording control can be performed on images and metadata acquired from an external device. Further, if decreasing the amount of data recorded in the recording device 904 is required, the reduction processing is performed on only the data that is not restricted from being deleted with reference to the summary information and the hierarchy summary information.

The recording control apparatus 902 according to the present exemplary embodiment can continue the image recording processing for the recording device 904 without losing specific images constituting an important scene even when the storage capacity of the recording device 904 is insufficient.

According to the above-mentioned exemplary embodiments, it is feasible to continue the image recording processing for the recording device without losing specific images constituting an important scene even when the storage capacity of the recording device is insufficient.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s).

The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-209217 filed Oct. 4, 2013, which is hereby incorporated by reference herein in its entirety.

What is claimed is:

1. A recording control apparatus, comprising:
a generation unit configured to generate metadata to determine whether a first subdirectory included in a first directory of a recording device includes an image to be restricted from being deleted from the recording device; and
a recording control unit configured to cause the first subdirectory to record a plurality of first images and cause the first directory to record first metadata generated by the generation unit.

2. The recording control apparatus according to claim 1, wherein
the generation unit is configured to generate the first metadata, which is metadata to determine whether the first subdirectory includes the image to be restricted from being deleted from the recording device and is also to determine whether a second subdirectory included in the first directory includes the image to be restricted from being deleted from the recording device, and
the recording control unit is configured to cause the second subdirectory to record a plurality of second images.

3. The recording control apparatus according to claim 1, wherein
the generation unit is configured to generate the metadata to identify the image to be restricted from being deleted from the recording device among a plurality of images, and
the recording control unit is configured to cause the first directory to record the first metadata generated by the generation unit and cause the first subdirectory to record the plurality of first images, and is further configured to cause the first subdirectory to record second metadata to identify the image to be restricted from being deleted from the recording device among the plurality of first images.

4. The recording control apparatus according to claim 1, wherein the recording control unit is configured to move the first directory recorded in the recording device, together with the first subdirectory, to a second directory and is configured to determine whether the first subdirectory included in the second directory includes the image to be restricted from being deleted from the recording device based on the first metadata.

5. A method for controlling a recording control apparatus, comprising:
generating metadata to determine whether a first subdirectory included in a first directory of a recording device includes a image to be restricted from being deleted from the recording device; and
performing a recording control to cause the first subdirectory to record a plurality of first images and cause the first directory to record generated first metadata.

6. The control method according to claim 5, wherein
the generation includes generating the first metadata, which is metadata to determine whether the first subdirectory includes the image to be restricted from being deleted from the recording device and is also to determine whether a second subdirectory included in the first directory includes the image to be restricted from being deleted from the recording device, and
the recording control includes causing the second subdirectory to record a plurality of second images.

7. A non-transitory computer readable storage medium containing computer-executable instructions that control a computer, the medium comprising:
computer-executable instructions for generating metadata to determine whether a first subdirectory included in a first directory of a recording device includes an image to be restricted from being deleted from the recording device; and
computer-executable instructions for causing the first subdirectory to record a plurality of first images and causing the first directory to record generated first metadata.

8. A recording control apparatus, comprising:
a recording unit configured to record an image included in a captured video data in association with an event having occurred in an image capturing period;
an identification unit configured to identify an image associated with a predetermined type of event among a plurality of images recorded in the recording unit;
a generation unit configured to generate summary information to identify an image associated with the predetermined type of event, based on an identification result obtained by the identification unit; and
a determination unit configured to determine an image to be deleted as an erasable part of a plurality of images recorded in the recording unit, based on the summary information generated by the generation unit.

9. The recording control apparatus according to claim 8, further comprising a recording control unit configured to cause a first subdirectory included in a first directory to record a plurality of first images and cause the first directory to record the summary information generated by the generation unit.

10. The recording control apparatus according to claim 8, further comprising:
an acquisition unit configured to acquire control information about contents of a control performed for an imaging unit configured to capture the plurality of images,
wherein the generation unit is configured to generate summary data based on the control information.

11. The recording control apparatus according to claim 9, further comprising:
a determination unit configured to determine a capacity of data that can be recorded in the recording device based on the summary data generated by the generation unit,
wherein the recording control unit is configured to perform a control to delete image data recorded in the recording device if the determination unit determines that the capacity of data that can be recorded in the recording device is less than a predetermined amount.

12. The recording control apparatus according to claim 8, further comprising:
a detection unit configured to detect a first event having occurred in a video constituted by the plurality of images and detect a second event having occurred in the video, in which the second event is different from the first event in type,
wherein the generation unit is configured to generate the summary information to identify restriction of a first image from being deleted if the first image constitutes a video of a first period including a period in which the first event has occurred, and is also configured to generate the summary information to identify restriction of a second image from being deleted if the second image constitutes a video of a second period including a period in which the second event has occurred, and
the determination unit is configured to determine the image to be deleted between the first image and the second image according to the type of the event detected by the detection unit, when deleting the first image or the second image is required.

13. The recording control apparatus according to claim 8, further comprising:
an acquisition unit configured to acquire event information indicating an occurrence of a predetermined event in video data constituted by the plurality of images,
wherein the generation unit is configured to generate the summary information to identify restriction of an image constituting a video scene in which the predetermined event has occurred from being deleted.

14. The recording control apparatus according to claim 8, wherein
the generation unit is configured to acquire information about the first time when a moving body has appeared in video data constituted by the plurality of images and second time when the moving body has disappeared from the video data, and
if the moving body is identified as a predetermined object during a time period from the first time to the second time, the generation unit generates the summary information to identify an image constituting video data including the time period from the first time to the second time as the image to be restricted from being deleted.

15. A method for controlling a recording device, comprising:
recording an image included in a captured video data in association with an event having occurred in an image capturing period;
identifying an image associated with a predetermined type of event among a plurality of images recorded in the recording unit;
generating summary information to identify an image associated with the predetermined type of event based on an identification result; and
determining an image to be deleted as an erasable part of the plurality of images recorded in the recording unit, based on the generated summary information.

16. The control method according to claim 15, further comprising:
detecting a predetermined event having occurred in a video constituted by the plurality of images,
wherein the generation includes generating the summary information to identify restriction of an image constituting a video scene in which the predetermined event has occurred from being deleted.

17. A non-transitory computer readable storage medium containing computer-executable instructions that control a computer, the medium comprising:
computer-executable instructions for causing a recording unit to record an image included in a captured video data in association with an event having occurred in an image capturing period;
computer-executable instructions for identifying an image associated with a predetermined type of event among a plurality of images recorded in the recording unit;
computer-executable instructions for generating summary information to identify an image associated with the predetermined type of event based on an identification result; and
computer-executable instructions for determining an image to be deleted as an erasable part of the plurality of images recorded in the recording unit, based on the generated summary information.
